(19) United States
(12) Patent Application Publication
(10) Pub. No.: US 2021/0157430 A1
(43) Pub. Date: May 27, 2021

(54) TOUCH DISPLAY PANEL AND TOUCH DISPLAY DEVICE

(71) Applicants: HEFEI BOE OPTOELECTRONICS TECHNOLOGY CO., LTD., Hefei (CN); BOE TECHNOLOGY GROUP CO., LTD., Beijing (CN)

(72) Inventor: Chengwei LI, Beijing (CN)

(73) Assignees: HEFEI BOE OPTOELECTRONICS TECHNOLOGY CO., LTD., Hefei (CN); BOE TECHNOLOGY GROUP CO., LTD., Beijing (CN)

(21) Appl. No.: 16/836,301

(22) Filed: Mar. 31, 2020

(30) Foreign Application Priority Data
Nov. 26, 2019 (CN) 201911172258.9

(51) Int. Cl. G06F 3/041

(52) U.S. Cl. CPC G06F 3/0412; G06F 2203/04103

(57) ABSTRACT

A touch display panel and a touch display device are provided. The touch display panel includes: a display substrate; multiple sub-pixel units arranged in an array on the display substrate; and a first touch electrode group comprising multiple touch units arranged in an array on the display substrate. Each touch unit comprises multiple electrically connected touch electrode blocks, and an orthographic projection of each touch electrode block onto the display substrate is within an orthographic projection of a corresponding sub-pixel unit onto the display substrate. A positional relationship between two adjacent touch electrode blocks comprises: two sub-pixel units corresponding to two adjacent touch electrode blocks in the same row being spaced apart by x sub-pixel units, x being a positive integer; and/or two sub-pixel units corresponding to two adjacent touch electrode blocks in the same column being spaced apart by x sub-pixel units.

### CROSS-REFERENCE TO RELATED APPLICATION

This application claims priority to Chinese Patent Application No. 201911172258.9 filed on Nov. 26, 2019, which is incorporated herein by reference in its entirety.

### TECHNICAL FIELD

The present disclosure relates to the field of touch display technologies, and in particular to a touch display panel and a touch display device.

### BACKGROUND

With the rapid development of liquid crystal display (LCD) technology, the touch display technology is increasingly widely applied in various smart terminals such as mobile phones, vehicles and medical instruments. At present, the touch screen market is basically occupied by capacitive projection touch screens. The capacitive projection touch screen is divided into a self-capacitive touch screen and a mutual capacitance touch screen, and is to detect a positon where a finger touches based on a change of a capacitance detected by a touch integrated circuit (IC). The self-capacitance touch screen senses the capacitance change of one electrode, and only one electrode layer is needed, so the production cost is low, while the mutual capacitance touch screen requires two electrode layers. In order to pursue simple and lightweight touch screen structures, in-cell touch screens have become mainstream and have been widely used in the touch display technologies.

### SUMMARY

In a first aspect, a touch display panel is provided according to embodiments of the present disclosure, which includes: a display substrate; a plurality of sub-pixel units arranged in an array on the display substrate; and a first touch electrode group including a plurality of touch units arranged in an array on the display substrate. At least one of the plurality of touch units includes a plurality of touch electrode blocks that is electrically connected, each of the plurality of touch electrode blocks is disposed corresponding to one sub-pixel unit, and an orthographic projection of each touch electrode block onto the display substrate is within an orthographic projection of the corresponding sub-pixel unit onto the display substrate. A positional relation between two adjacent touch electrode blocks includes at least one of: two adjacent touch electrode blocks being located in a same row, and two sub-pixel units corresponding to the two adjacent touch electrode blocks in the same row being spaced apart by x sub-pixel units, x being a positive integer; or two adjacent touch electrode blocks being located in a same column, and two sub-pixel units corresponding to the two adjacent touch electrode blocks in the same column being spaced apart by x sub-pixel units.

In some optional embodiments, x=1, two sub-pixel units corresponding to each two adjacent touch electrode blocks in a same row are spaced apart by one sub-pixel unit, and two sub-pixel units corresponding to each two adjacent touch electrode blocks in a same column are spaced apart by one sub-pixel unit.

In some optional embodiments, the plurality of touch units includes first touch units and second touch units, and the first touch units and the second touch units are arranged alternately in a row direction and in a column direction; and an arrangement manner of touch electrode blocks included in each of the first touch units is different from an arrangement manner of touch electrode blocks included in each of the second touch units.

In some optional embodiments, the number of touch electrode blocks included in each of the first touch units is different from the number of touch electrode blocks included in each of the second touch units.

In some optional embodiments, a touch unit in an a-th row and a b-th column is electrically connected to a touch control circuit of the touch display panel through a lead in the a-th row and the b-th column, and a touch unit in an (a+1)-th row and the b-th column is electrically connected to the touch control circuit through a lead in the (a+1)-th row and the b-th column, a and b being positive integers. The lead in the a-th row and b-th column is located on a left side of the touch unit in the a-th row and b-th column, and the lead in the (a+1)-th row and the b-th column is located on a right side of the touch unit in the (a+1)-th row and the b-th column; or the lead in the a-th row and the b-th column is located on a right side of the touch unit in the a-th row and the b-th column, and the lead in the (a+1)-th row and the b-th column is located on a left side of the touch unit in the (a+1)-th row and the b-th column.

In some optional embodiments, each of the first touch units includes five touch electrode blocks, four touch electrode blocks of the five touch electrode blocks are located in two rows, a square is formed by connected lines between any adjacent touch electrode blocks of the four touch electrode blocks, and the remaining touch electrode of the five touch electrode blocks is located at a center of the square.

In some optional embodiments, each of the second touch units includes four touch electrode blocks, the four touch electrode blocks of the second touch unit are located in three rows, and a square is formed by connected lines between any adjacent touch electrode blocks of the four touch electrode blocks of the second touch unit.

In some optional embodiments, each of the first touch units includes five touch electrode blocks, and the touch display panel includes a sub-pixel unit in an m-th row and an n-th column, a sub-pixel unit in the m-th row and an (n+1)-th column, a sub-pixel unit in the m-th row and an (n+2)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in an (m+2)-th row and the n-th column, a sub-pixel unit in the (m+2)-th row and the (n+1)-th column, and a sub-pixel unit in the (m+2)-th row and the (n+2)-th column, m and n being positive integers; where:

an orthographic projection of a first touch electrode block in the first touch unit onto the display substrate is within an orthographic projection of the sub-pixel unit in the m-th row and the n-th column onto the display substrate;

an orthographic projection of a second touch electrode block in the first touch unit onto the display substrate is within an orthographic projection of the sub-pixel unit in the m-th row and the (n+2)-th column onto the display substrate;

an orthographic projection of a third touch electrode block in the first touch unit onto the display substrate is within an orthographic projection of the sub-pixel unit in the (m+1)-th row and the (n+1)-th column onto the display substrate;

an orthographic projection of a fourth touch electrode block in the first touch unit onto the display substrate is within an orthographic projection of the sub-pixel unit in the (m+2)-th row and the n-th column onto the display substrate; and

an orthographic projection of a fifth touch electrode block in the first touch unit onto the display substrate is within an orthographic projection of the sub-pixel unit in the (m+2)-th row and the (n+2)-th column onto the display substrate.

In some optional embodiments, each of the second touch units includes four touch electrode blocks, and the touch display panel includes a sub-pixel unit in an m-th row and an n-th column, a sub-pixel unit in the m-th row and an (n+1)-th column, a sub-pixel unit in the m-th row and an (n+2)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in an (m+2)-th row and the n-th column, a sub-pixel unit in the (m+2)-th row and the (n+1)-th column and a sub-pixel unit in the (m+2)-th row and the (n+2)-th column, m and n being positive integers; where:

an orthographic projection of a first touch electrode block in the second touch unit onto the display substrate is within an orthographic projection of the sub-pixel unit in the m-th row and the (n+1)-th column onto the display substrate;

an orthographic projection of a second touch electrode block in the second touch unit onto the display substrate is within an orthographic projection of the sub-pixel unit in the (m+1)-th row and the n-th column onto the display substrate;

an orthographic projection of a third touch electrode block in the second touch unit onto the display substrate is within an orthographic projection of the sub-pixel unit in the (m+1)-th row and the (n+2)-th column onto the display substrate; and

an orthographic projection of a fourth touch electrode block in the second touch unit onto the display substrate is within an orthographic projection of the sub-pixel unit in the (m+2)-th row and the (n+1)-th column onto the display substrate.

In some optional embodiments, each of the first touch units includes two touch electrode blocks, and the touch display panel includes a sub-pixel unit in an m-th row and an n-th column, a sub-pixel unit in the m-th row and an (n+1)-th column, a sub-pixel unit in an (m+1)-th row and the n-th column and a sub-pixel unit in the (m+1)-th row and the (n+1)-th column, m and n being positive integers. An orthographic projection of a first touch electrode block in the first touch unit onto the display substrate is within an orthographic projection of the sub-pixel unit in the m-th row and the n-th column onto the display substrate; and an orthographic projection of a second touch electrode block in the first touch unit onto the display substrate is within an orthographic projection of the sub-pixel unit in the (m+1)-th row and the (n+1)-th column onto the display substrate.

In some optional embodiments, each of the second touch units includes two touch electrode blocks, and the touch display panel includes a sub-pixel unit in an m-th row and an n-th column, a sub-pixel unit in the m-th row and an (n+1)-th column, a sub-pixel unit in an (m+1)-th row and the n-th column and a sub-pixel unit in the (m+1)-th row and the (n+1)-th column, m and n being positive integers. An orthographic projection of a first touch electrode block in the second touch unit onto the display substrate is within an orthographic projection of the sub-pixel unit in the m-th row and the (n+1)-th column onto the display substrate; and an orthographic projection of a second touch electrode block in the second touch unit onto the display substrate is within an orthographic projection of the sub-pixel unit in the (m+1)-th row and the n-th column onto the display substrate.

In some optional embodiments, each of the first touch units includes five touch electrode blocks, and each of the second touch units includes four touch electrode blocks. The touch display panel includes a sub-pixel unit in an m-th row and an n-th column, a sub-pixel unit in the m-th row and an (n+1)-th column, a sub-pixel unit in the m-th row and an (n+2)-th column, a sub-pixel unit in the m-th row and an (n+3)-th column, a sub-pixel unit in the m-th row and an (n+4)-th column, a sub-pixel unit in the m-th row and an (n+5)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in the (m+1)-th row and the (n+3)-th column, a sub-pixel unit in the (m+1)-th row and the (n+4)-th column, a sub-pixel unit in the (m+1)-th row and the (n+5)-th column, a sub-pixel unit in an (m+2)-th row and the n-th column, a sub-pixel unit in the (m+2)-th row and the (n+1)-th column, a sub-pixel unit in the (m+2)-th row and the (n+2)-th column, a sub-pixel unit in the (m+2)-th row and the (n+3)-th column, a sub-pixel unit in the (m+2)-th row and the (n+4)-th column, and a sub-pixel unit in the (m+2)-th row and the (n+5)-th column, m and n being positive integers; where:

an orthographic projection of a first touch electrode block in the first touch unit onto the display substrate is within an orthographic projection of the sub-pixel unit in the m-th row and the n-th column onto the display substrate;

an orthographic projection of a second touch electrode block in the first touch unit onto the display substrate is within an orthographic projection of the sub-pixel unit in the m-th row and the (n+2)-th column onto the display substrate;

an orthographic projection of a third touch electrode block in the first touch unit onto the display substrate is within an orthographic projection of the sub-pixel unit in the (m+1)-th row and the (n+1)-th column onto the display substrate;

an orthographic projection of a fourth touch electrode block in the first touch unit onto the display substrate is within an orthographic projection of the sub-pixel unit in the (m+2)-th row and the n-th column onto the display substrate;

an orthographic projection of a fifth touch electrode block in the first touch unit onto the display substrate is within an orthographic projection of the sub-pixel unit in the (m+2)-th row and the (n+2)-th column onto the display substrate;

an orthographic projection of a first touch electrode block in the second touch unit onto the display substrate is within an orthographic projection of the sub-pixel unit in the m-th row and the (n+4)-th column onto the display substrate;

an orthographic projection of a second touch electrode block in the second touch unit onto the display substrate is within an orthographic projection of the sub-pixel unit in the (m+1)-th row and the (n+3)-th column onto the display substrate;

an orthographic projection of a third touch electrode block in the second touch unit onto the display substrate is within an orthographic projection of the sub-pixel unit in the (m+1)-th row and the (n+5)-th column onto the display substrate; and

an orthographic projection of a fourth touch electrode block in the second touch unit onto the display substrate is within an orthographic projection of the sub-pixel unit in the (m+2)-th row and the (n+4)-th column onto the display substrate.

In some optional embodiments, each of the first touch units includes two touch electrode blocks, and each of the second touch units includes two touch electrode blocks, and the touch display panel includes a sub-pixel unit in an m-th row and an n-th column, a sub-pixel unit in the m-th row and an (n+1)-th column, a sub-pixel unit in the m-th row and an (n+2)-th column, a sub-pixel unit in the m-th row and an (n+3)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in the (m+1)-th row and the (n+3)-th column, m and n being positive integers; where:

an orthographic projection of a first touch electrode block in the first touch unit onto the display substrate is within an orthographic projection of the sub-pixel unit in the m-th row and the n-th column onto the display substrate; and

an orthographic projection of a second touch electrode block in the first touch unit onto the display substrate is within an orthographic projection of the sub-pixel unit in the (m+1)-th row and the (n+1)-th column onto the display substrate;

an orthographic projection of a first touch electrode block in the second touch unit onto the display substrate is within an orthographic projection of the sub-pixel unit in the m-th row and the (n+3)-th column onto the display substrate; and

an orthographic projection of a second touch electrode block in the second touch unit onto the display substrate is within an orthographic projection of the sub-pixel unit in the (m+1)-th row and the (n+2)-th column onto the display substrate.

In some optional embodiments, shapes of the plurality of touch electrode blocks are the same, and the sizes of the plurality of touch electrode blocks are the same.

In some optional embodiments, the touch display panel further includes a second touch electrode group, where the second touch electrode group includes a plurality of second touch electrodes, and each of the plurality of the second touch electrodes is a strip-shaped touch electrode, and is disposed between adjacent rows of sub-pixel units.

In a second aspect, a touch display device is provided according to embodiments of the present disclosure, which includes the above touch display panel.

### BRIEF DESCRIPTION OF THE DRAWINGS

FIG. 1 is a schematic diagram of a touch unit according to embodiments of the present disclosure;

FIG. 2 is a schematic diagram of a touch unit according to embodiments of the present disclosure;

FIG. 3 is a schematic diagram of a touch unit according to embodiments of the present disclosure;

FIG. 4 is a schematic diagram of a touch unit according to embodiments of the present disclosure;

FIG. 5 is a schematic diagram of a touch electrode group according to embodiments of the present disclosure;

FIG. 6 is a schematic diagram of a connection between a touch electrode group and a touch control circuit according to embodiments of the present disclosure; and

FIG. 7 is a schematic diagram of a touch display panel according to embodiments of the present disclosure.

### DETAILED DESCRIPTION

The technical solutions in embodiments of the present disclosure will be clearly and completely described below with reference to the accompanying drawings in the embodiments of the present disclosure. Obviously, the described embodiments are only a part of the embodiments of the present disclosure rather than all of the embodiments. Based on the embodiments in the present disclosure, all other embodiments obtained by a person of ordinary skill in the art without creative efforts shall fall within the protection scope of the present disclosure.

In an in-cell touch screen in related technology, capacitive blocks of each touch electrode have the same size as capacitive blocks of each other touch electrode, and the recognition accuracy of touch in a terminal may be insufficient. The touch electrodes are located on an array substrate, and during a touch, there is a coupling capacitance between the touch electrodes and data lines that overlap, which results in a slow response speed of the touch display.

Moreover, in the touch screen in the related technology, touch amounts of different touch units are the same, and a position of a touch point cannot be effectively recognized in touch recognition, which causes a low touch recognition accuracy. In addition, leads of different touch electrodes are usually located on the same side of a sub-pixel unit, which causes uneven distribution of the leads, and the number of data lines covered by electrode blocks of a touch unit is different from the number of data lines covered by electrode blocks of another touch unit, which adversely affects the uniformity of touch.

In view of the above, a touch display panel and a touch display device are provided according to embodiments of the present disclosure, so as to improve a response speed of touch display, the accuracy of touch recognition and the uniformity of touch.

A touch display panel is provided according to an embodiment of the present disclosure, which includes: a display substrate; a plurality of sub-pixel units arranged in an array on the display substrate; and a first touch electrode group including a plurality of touch units arranged in an array on the display substrate. At least one of the plurality of touch units includes a plurality of touch electrode blocks that is electrically connected, each of the plurality of touch electrode blocks is disposed corresponding to one sub-pixel unit, and an orthographic projection of each touch electrode block onto the display substrate is within an orthographic projection of the corresponding sub-pixel unit onto the display substrate. A positional relationship between two adjacent touch electrode blocks includes at least one of: two adjacent touch electrode blocks being located in a same row, and two sub-pixel units corresponding to the two adjacent touch electrode blocks in the same row being spaced apart by x sub-pixel units, x being a positive integer; or two adjacent touch electrode blocks being located in a same column, and two sub-pixel units corresponding to the two adjacent touch electrode blocks in the same column being spaced apart by x sub-pixel units.

In specific implementations, two adjacent touch electrode blocks may be located in different rows or columns.

According to the embodiment of the present disclosure, the touch unit includes a plurality of mutually connected touch electrode blocks on the display substrate, and an orthographic projection of each touch electrode block onto the display substrate falls within an orthographic projection of the corresponding sub-pixel unit onto the display substrate, which enables the orthographic projection of each touch electrode block onto the display substrate not to overlap an orthographic projection of a data line corresponding to the touch electrode block onto the display substrate. In such a manner, during a touch stage, there is no coupling capacitor between each touch electrode block and the corresponding data line, thereby improving the response speed of touch display. In addition, two sub-pixel units corresponding to each two adjacent touch electrode blocks in the same row are spaced apart by x sub-pixel units, and/or two sub-pixel units corresponding to each two adjacent touch electrode blocks in the same column are spaced apart by x sub-pixel units, which makes touch electrode blocks evenly distributed, thereby improving the touch uniformity of the touch display panel.

Optionally, x=1, two sub-pixel units corresponding to each two adjacent touch electrode blocks in a same row are spaced apart by one sub-pixel unit, and two sub-pixel units corresponding to each two adjacent touch electrode blocks in a same column are spaced apart by one sub-pixel unit.

Optionally, the plurality of touch units includes first touch units and second touch units, and the first touch units and the second touch units are arranged alternately in a row direction and in a column direction; and an arrangement manner of touch electrode blocks included in the first touch unit is different from an arrangement manner of touch electrode blocks included in the second touch unit.

Optionally, the number of touch electrode blocks included in the first touch unit is different from the number of touch electrode blocks included in the second touch unit.

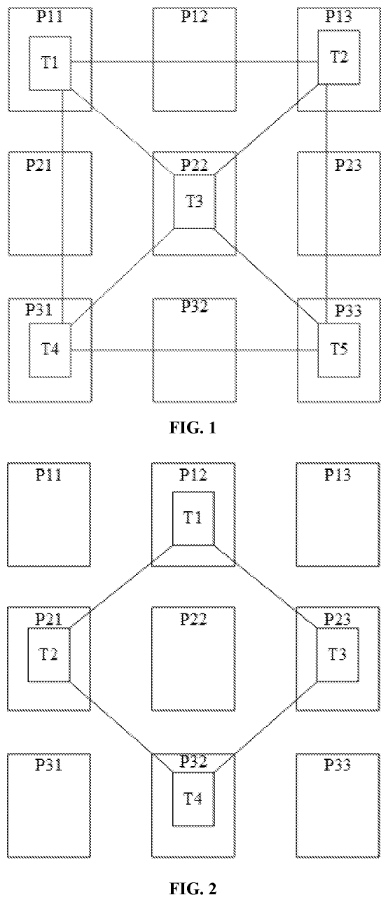

Optionally, each of the first touch units includes five touch electrode blocks, four touch electrode blocks of the five touch electrode blocks are located in two rows, a square is formed by connected lines between any adjacent touch electrode blocks of the four touch electrode blocks, and the remaining touch electrode of the five touch electrode blocks is located at a center of the square, which is as shown in FIG. 1.

Optionally, each of the second touch units includes four touch electrode blocks, the four touch electrode blocks of the second touch unit are located in three rows, and a square is formed by connected lines between any adjacent touch electrode blocks of the four touch electrode blocks of the second touch unit, which is as shown in FIG. 2.

In an embodiment of the present disclosure, the display substrate may be an array substrate, but is not limited thereto.

In an embodiment of the present disclosure, the touch display panel includes an array substrate and a touch unit. The array substrate is provided with intersected gate lines and data lines, and the plurality of sub-pixels is defined by the intersected gate lines and data lines.

In actual operations, each touch electrode block may be a capacitor block, but is not limited thereto.

In a specific implementation, shapes of the plurality of touch electrode blocks included in a touch unit may be the same, the sizes of the plurality of touch electrode blocks included in a touch unit may be the same, and the size of each touch electrode block is not larger than the size of a corresponding sub-pixel unit, which is not limited herein.

According to a specific embodiment, each of the first touch units may include five touch electrode blocks.

In some optional embodiments, the touch display panel includes a sub-pixel unit in an m-th row and an n-th column, a sub-pixel unit in the m-th row and an (n+1)-th column, a sub-pixel unit in the m-th row and an (n+2)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in an (m+2)-th row and the n-th column, a sub-pixel unit in the (m+2)-th row and the (n+1)-th column, and a sub-pixel unit in the (m+2)-th row and the (n+2)-th column, m and n being positive integers; where:

an orthographic projection of a first touch electrode block included in the touch unit onto the display substrate is within an orthographic projection of the sub-pixel unit in the m-th row and the n-th column onto the display substrate;

an orthographic projection of a second touch electrode block included in the touch unit onto the display substrate is within an orthographic projection of the sub-pixel unit in the m-th row and the (n+2)-th column onto the display substrate;

an orthographic projection of a third touch electrode block included in the touch unit onto the display substrate is within an orthographic projection of the sub-pixel unit in the (m+1)-th row and the (n+1)-th column onto the display substrate;

an orthographic projection of a fourth touch electrode block included in the touch unit onto the display substrate is within an orthographic projection of the sub-pixel unit in the (m+2)-th row and the n-th column onto the display substrate; and

an orthographic projection of a fifth touch electrode block included in the touch unit onto the display substrate is within an orthographic projection of the sub-pixel unit in the (m+2)-th row and the (n+2)-th column onto the display substrate.

In some optional embodiments, as shown in FIG. 1, the touch unit may include a first touch electrode block T1, a second touch electrode block T2, a third touch electrode block T3, a fourth touch electrode block T4 and a fifth touch electrode block T5.

The touch display panel includes a sub-pixel unit P11 in the first row and the first column, a sub-pixel unit P12 in the first row and the second column, a sub-pixel unit P13 in the first row and the third column, a sub-pixel unit P21 in the second row and the first column, a sub-pixel unit P22 in the second row and the second column, a sub-pixel unit P23 in the second row and the third column, a sub-pixel unit P31 in the third row and the first column, a sub-pixel unit P32 in the third row and the second column, and a sub-pixel unit P33 in the third row and the third column.

An orthographic projection of T1 onto the display substrate is within an orthographic projection of the sub-pixel unit P11 in the first row and the first column onto the display substrate.

An orthographic projection of T2 onto the display substrate is within an orthographic projection of the sub-pixel unit P13 in the first row and the third column onto the display substrate.

An orthographic projection of T3 onto the display substrate is within an orthographic projection of the sub-pixel unit P22 in the second row and the second column onto the display substrate.

An orthographic projection of T4 onto the display substrate is within an orthographic projection of the sub-pixel unit P31 in the third row and the first column onto the display substrate.

An orthographic projection of T5 onto the display substrate is within an orthographic projection of the sub-pixel unit P33 in the third row and the third column onto the display substrate.

Touch electrode blocks T1, T2, T3, T4 and T5 are electrically connected to each other.

According to another specific implementation, the touch unit may include four touch electrode blocks. The touch display panel includes a sub-pixel unit in an m-th row and an n-th column, a sub-pixel unit in the m-th row and an (n+1)-th column, a sub-pixel unit in the m-th row and an (n+2)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in an (m+2)-th row and the n-th column, a sub-pixel unit in the (m+2)-th row and the (n+1)-th column and a sub-pixel unit in the (m+2)-th row and the (n+2)-th column, m and n being positive integers; where:

an orthographic projection of a first touch electrode block included in the touch unit onto the display substrate is within an orthographic projection of the sub-pixel unit in the m-th row and the (n+1)-th column onto the display substrate;

an orthographic projection of a second touch electrode block included in the touch unit onto the display substrate is within an orthographic projection of the sub-pixel unit in the (m+1)-th row and the n-th column onto the display substrate;

an orthographic projection of a third touch electrode block included in the touch unit onto the display substrate is within an orthographic projection of the sub-pixel unit in the (m+1)-th row and the (n+2)-th column onto the display substrate; and

an orthographic projection of a fourth touch electrode block included in the touch unit onto the display substrate is within an orthographic projection of the sub-pixel unit in the (m+2)-th row and the (n+1)-th column onto the display substrate.

FIG. 2 is a schematic diagram of a touch unit according to embodiments of the present disclosure. As shown in FIG. 2, the touch unit according to embodiments may include a first touch electrode block T1, a second touch electrode block T2, a third touch electrode block T3, and a fourth touch electrode block T4. The touch display panel includes a sub-pixel unit P11 in the first row and the first column, a sub-pixel unit P12 in the first row and the second column, a sub-pixel unit P13 in the first row and the third column, a sub-pixel unit P21 in the second row and the first column, a sub-pixel unit P22 in the second row and the second column, a sub-pixel unit P23 in the second row and the third column, a sub-pixel unit P31 in the third row and the first column, a sub-pixel unit P32 in the third row and the second column, and a sub-pixel unit P33 in the third row and the third column.

An orthographic projection of T1 onto the display substrate is within an orthographic projection of the sub-pixel unit P12 in the first row and the second column onto the display substrate.

An orthographic projection of T2 onto the display substrate is within an orthographic projection of the sub-pixel unit P21 in the second row and first column onto the display substrate.

An orthographic projection of T3 onto the display substrate is within an orthographic projection of the sub-pixel unit P23 in the second row and third column onto the display substrate.

An orthographic projection of T4 onto the display substrate is within an orthographic projection of the sub-pixel unit P31 in the third row and first column onto the display substrate.

Touch electrode blocks T1, T2, T3 and T4 are electrically connected to each other.

According to another specific implementation, the touch unit may include two touch electrode blocks. The touch display panel includes a sub-pixel unit in an m-th row and an n-th column, a sub-pixel unit in the m-th row and an (n+1)-th column, a sub-pixel unit in an (m+1)-th row and the n-th column and a sub-pixel unit in the (m+1)-th row and the (n+1)-th column, m and n being positive integers. An orthographic projection of a first touch electrode block included in the touch unit onto the display substrate is within an orthographic projection of the sub-pixel unit in the m-th row and the n-th column onto the display substrate; and an orthographic projection of a second touch electrode block included in the touch unit onto the display substrate is within an orthographic projection of the sub-pixel unit in the (m+1)-th row and the (n+1)-th column onto the display substrate.

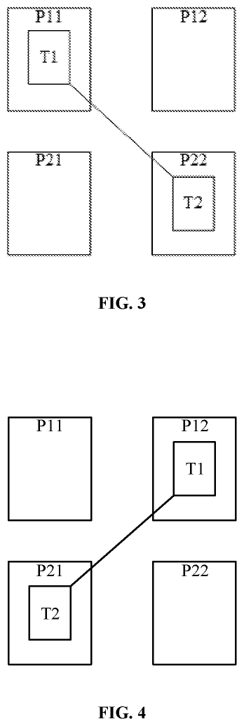

FIG. 3 is a schematic diagram of a touch unit according to embodiments of the present disclosure. As shown in FIG. 3, the touch unit according to embodiments may include a first touch electrode block T1 and a second touch electrode block T2. The touch display panel includes a sub-pixel unit P11 in the first row and first column, a sub-pixel unit P12 in the first row and second column, a sub-pixel unit P21 in the second row and first column, and a sub-pixel unit P22 in the second row and second column.

An orthographic projection of T1 onto the display substrate is within an orthographic projection of the sub-pixel unit P11 in the first row and first column onto the display substrate.

An orthographic projection of T2 onto the display substrate is within an orthographic projection of the sub-pixel unit P22 in the second row and second column onto the display substrate.

Touch electrode blocks T1 and T2 are electrically connected to each other.

According to another embodiment, each of the first touch units includes two touch electrode blocks, and the touch display panel includes a sub-pixel unit in an m-th row and an n-th column, a sub-pixel unit in the m-th row and an (n+1)-th column, a sub-pixel unit in an (m+1)-th row and the n-th column and a sub-pixel unit in the (m+1)-th row and the (n+1)-th column, m and n being positive integers. An orthographic projection of a first touch electrode block in the second touch unit onto the display substrate is within an orthographic projection of the sub-pixel unit in the m-th row and the (n+1)-th column onto the display substrate; and an orthographic projection of a second touch electrode block in the second touch unit onto the display substrate is within an orthographic projection of the sub-pixel unit in the (m+1)-th row and the n-th column onto the display substrate.

FIG. 4 is a schematic diagram of a touch unit according to embodiments of the present disclosure. As shown in FIG. 4, the touch unit according to the embodiments may include a first touch electrode block T1 and a second touch electrode block T2. The touch display panel includes a sub-pixel unit P11 in the first row and first column, a sub-pixel unit P12 in the first row and second column, a sub-pixel unit P21 in the second row and first column, and a sub-pixel unit P22 in the second row and second column.

An orthographic projection of T1 onto the display substrate is within an orthographic projection of the sub-pixel unit P12 in the first row and the second column onto the display substrate.

An orthographic projection of T2 onto the display substrate is within an orthographic projection of the sub-pixel unit P21 in the second row and the first column onto the display substrate.

Touch electrode blocks T1 and T2 are electrically connected to each other.

In actual operations, the structure of the touch unit according to the embodiments is not limited to the above four examples, and different sizes of touch units can be set according to different touch accuracy.

In the touch electrode group according to the embodiments of the present disclosure, the structure of each touch unit is different from structures of four touch units immediately adjacent to the touch unit. In such a structure, any two adjacent touch units have different arrangements and different numbers of touch electrode blocks, so that any two adjacent touch units have different touch amounts during a touch operation, which can effectively recognize a position of a touch point in mobile touch, thereby improving the accuracy of touch recognition.

In addition, the arrangement of touch electrode blocks of the first touch unit and the arrangement of touch electrode blocks of the second touch unit can be in a complementary relationship. For example, the first touch unit includes five touch electrode blocks as shown in FIG. 1, while the second touch unit includes four touch electrode blocks as shown in FIG. 2, and after the first touch unit and the second touch unit are overlapped, orthographic projections of nine touch electrode blocks onto the display substrate are exactly within the 3×3 sub-pixel units, i.e., within the sub-pixel units with three rows and three columns.

Specifically, the number of the first touch units may be multiple, and the number of the second touch units may be multiple.

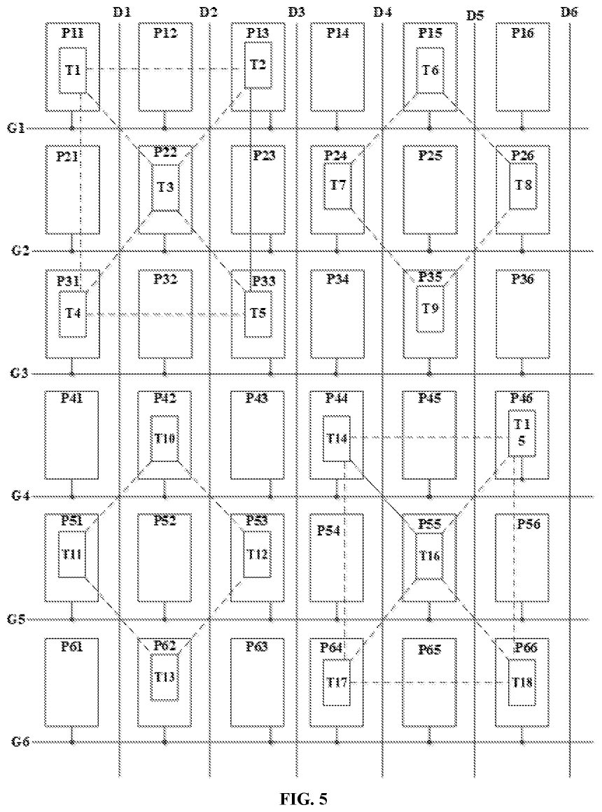

FIG. 5 is a schematic diagram of a touch electrode group according to embodiments of the present disclosure. As shown in FIG. 5, the touch electrode group according to the embodiments of the present disclosure is applied to a touch display panel, and the touch electrode group includes two first touch units and two second touch units. The first touch unit and the second touch unit are arranged adjacent to each other, and a structure of the first touch unit is different from a structure of the second touch unit.

The touch electrode group according to the embodiments of the present disclosure includes the first touch unit located in a first row and a first column, the second touch unit located in the first row and a second column, the second touch unit located in a second row and the first column, and the first touch unit located in the second row and the second column.

The first touch unit located in the first row and the first column includes a first touch electrode block T1, a second touch electrode block T2, a third touch electrode block T3, a fourth touch electrode block T4, and a fifth touch electrode block T5.

The second touch unit located in the first row and the second column includes a sixth touch electrode block T6, a seventh touch electrode block T7, an eighth touch electrode block T8, and a ninth touch electrode block T9.

The second touch unit located in the second row and the first column includes a tenth touch electrode block T10, an eleventh touch electrode block T11, a twelfth touch electrode block T12, and a thirteenth touch electrode block T13.

The first touch unit located in the second row and the second column includes a fourteenth touch electrode block T14, a fifteenth touch electrode block T15, a sixteenth touch electrode block T16, a seventeenth touch electrode block T17, and eighteenth touch electrode block T18.

The touch display panel includes six rows and six columns of sub-pixel units on the display substrate, which are: a sub-pixel unit P11 in the first row and the first column, a sub-pixel unit P12 in the first row and the second column, a sub-pixel unit P13 in the first row and the third column, a sub-pixel unit P14 in the first row and the fourth column, a sub-pixel unit P15 in the first row and the fifth column, a sub-pixel unit P16 in the first row and the sixth column, a sub-pixel unit P21 in the second row and the first column, a sub-pixel unit P22 in the second row and the second column, a sub-pixel unit P23 in the second row and the third column, a sub-pixel unit P24 in the second row and the fourth column, a sub-pixel unit P25 in the second row and the fifth column, a sub-pixel unit P26 in the second row and the sixth column, a sub-pixel unit P31 in the third row and the first column, a sub-pixel unit P32 in the third row and the second column, a sub-pixel unit P33 in the third row and third column, a sub-pixel unit P34 in the third row and the fourth column, a sub-pixel unit P35 in the third row and the fifth column, a sub-pixel unit P36 in the third row and the sixth column, a sub-pixel unit P41 in the fourth row and the first column, a sub-pixel unit P42 in the fourth row and the second column, a sub-pixel unit P43 in the fourth row and the third column, a sub-pixel unit P44 in the fourth row and the fourth column, a sub-pixel unit P45 in the fourth row and the fifth column, a sub-pixel unit P46 in the fourth row and the sixth column, a sub-pixel unit P51 in the fifth row and the first column, a sub-pixel unit P52 in the fifth row and the second column, a sub-pixel unit P53 in the fifth row and the third column, a sub-pixel unit P54 in the fifth row and the fourth column, a sub-pixel unit P55 in the fifth row and fifth column, a sub-pixel unit P56 in the fifth row and the sixth column, a sub-pixel unit P61 in the sixth row and the first column, a sub-pixel unit P62 in the sixth row and the second column, a sub-pixel unit P63 in the sixth row and the third column, a sub-pixel unit P64 in the sixth row and the fourth column, a sub-pixel unit P65 in the sixth row and the fifth column, and a sub-pixel unit P66 in the sixth row and the sixth column.

The touch display panel includes a first row of gate line G1, a second row of gate line G2, a third row of gate line G3, a fourth row of gate line G4, a fifth row of gate line G5, a sixth row of gate line G6, a first column of data line D1, a second column of data line D2, a third column of data line D3, a fourth column of data line D4, a fifth column of data line D5, and a sixth column of data line D6.

The orthographic projection of T1 onto the display substrate is within the orthographic projection of P11 onto the display substrate, the orthographic projection of T2 onto the display substrate is within the orthographic projection of P13 onto the display substrate, the orthographic projection of T3 onto the display substrate is within the orthographic projection of P22 onto the display substrate, the orthographic projection of T4 onto the display substrate is within the orthographic projection of P31 onto the display substrate, and the orthographic projection of T5 onto the display substrate is within the orthographic projection of P33 onto the display substrate.

The orthographic projection of T6 onto the display substrate is within the orthographic projection of P15 onto the display substrate, the orthographic projection of T7 onto the display substrate is within the orthographic projection of P24 onto the display substrate, the orthographic projection of T8 onto the display substrate is within the orthographic projection of P26 onto the display substrate, and the orthographic projection of T9 onto the display substrate is within the orthographic projection of P35 onto the display substrate.

The orthographic projection of T10 onto the display substrate is within the orthographic projection of P42 onto the display substrate, the orthographic projection of T11 onto the display substrate is within the orthographic projection of P51 onto the display substrate, the orthographic projection of T12 onto the display substrate is within the orthographic projection of P53 onto the display substrate, and the orthographic projection of T13 onto the display substrate is within the orthographic projection of P62 onto the display substrate.

The orthographic projection of T14 onto the display substrate is within the orthographic projection of P44 onto the display substrate, the orthographic projection of T15 onto the display substrate is within the orthographic projection of P46 onto the display substrate, the orthographic projection of T16 onto the display substrate is within the orthographic projection of P55 onto the display substrate, the orthographic projection of T17 onto the display substrate is within the orthographic projection of P64 onto the display substrate, and the orthographic projection of T18 onto the display substrate is within the orthographic projection of P66 onto the display substrate.

Touch electrode blocks T1, T2, T3, T4 and T5 are electrically connected to each other. Touch electrode blocks T6, T7, T8 and T9 are electrically connected to each other. Touch electrode blocks T10, T11, T12 and T13 are electrically connected to each other. Touch electrode blocks T14, T15, T16, T17 and T18 are electrically connected to each other.

In an embodiment shown in FIG. 5, all the touch units are touch sensing units, which are not limited thereto.

It can be seen from FIG. 5 that the structure of the first touch unit in the first row and the first column is different from the structure of the second touch unit in the first row and the second column. The structure of the second touch unit in the first row and the second column is different from the structure of the first touch unit in the second row and the second column. The structure of the first touch unit in the first row and the first column is different from the structure of the second touch unit in the second row and the first column. The structure of the second touch unit in the first row and the second column is different from the structure of the first touch unit in the second row and the second column.

In the embodiments shown in FIG. 5, P11, P16, P21, P26, P31, P36, P43, P44, P53, P54, P63 and P64 may be red sub-pixel units, but not limited thereto; P12, P14, P22, P24, P32, P34, P41, P45, P51, P55, P61 and P65 may be green sub-pixel units, but not limited to thereto; and P13, P15, P23, P25, P33, P35, P42, PR6, P52, P56, P62 and P66 may be blue sub-pixel units, but not limited thereto.

In the touch electrode group according to the embodiments shown in FIG. 5, any two adjacent touch electrode blocks in one row are spaced apart by one sub-pixel unit, and any two adjacent touch electrode blocks in one column are spaced apart by one sub-pixel unit. Such a combined arrangement makes touch electrode blocks uniformly distributed.

In the touch electrode group according to the embodiments shown in FIG. 5, an orthographic projection of each touch electrode block onto the display substrate do not overlap an orthographic projection of a corresponding data line onto the display substrate, which can improve a response speed.

Specifically, a touch unit in an a-th row and a b-th column is electrically connected to a touch control circuit of the touch display panel through a lead in the a-th row and the b-th column, and a touch unit in an (a+1)-th row and the b-th column is electrically connected to the touch control circuit through a lead in the (a+1)-th row and the b-th column, where each of a and b is a positive integer.

In an optional embodiment, the lead in the a-th row and b-th column is located on a left side of the touch unit in the a-th row and b-th column, and the lead in the (a+1)-th row and the b-th column is located on a right side of the touch unit in the (a+1)-th row and the b-th column; or the lead in the a-th row and the b-th column is located on a right side of the touch unit in the a-th row and the b-th column, and the lead in the (a+1)-th row and the b-th column is located on a left side of the touch unit in the (a+1)-th row and the b-th column.

In specific implementations, the touch units is electrically connected to the touch control circuit through corresponding leads, and the leads corresponding to the touch units in a same row may be arranged on the same side of the touch units, the leads corresponding to the touch units in an adjacent row may be arranged on the other side of the touch units.

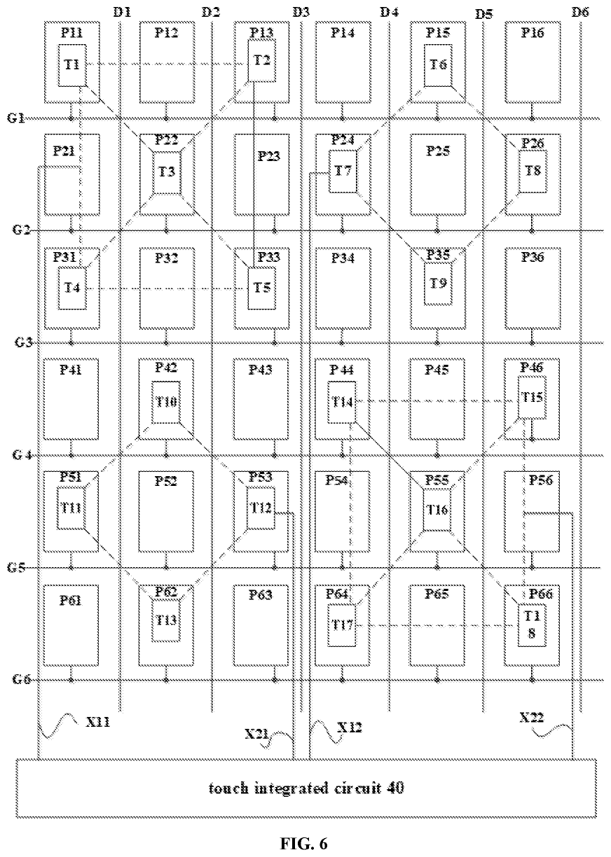

As shown in FIG. 6, based on the embodiments of the touch electrode group shown in FIG. 5, the first touch unit in the first row and the first column is electrically connected to the touch control circuit 40 via the first row and the first column of lead X11.

The second touch unit in the first row and the second column is electrically connected to the touch control circuit 40 via the first row and the second column of lead X12.

The second touch unit in the second row and the first column is electrically connected to the touch control circuit 40 via the second row and the first column of lead X21.

The first touch unit in the second row and the second column is electrically connected to the touch control circuit 40 via the second row and the second column of lead X22.

Lead X11 is located on the left side of the first touch unit in the first row and the first column, lead X12 is located on the left side of the second touch unit in the first row and the second column, lead X21 is located on the right side of the second touch unit in the second row and the first column, and lead X22 is located on the right side of the first touch unit in the second row and the second column, which effectively reduces coupling capacitances between data lines and touch electrode blocks and improves the uniformity of leads.

Optionally, the touch control circuit 40 may be an integrated circuit, such as an integrated circuit that integrates the touch control circuit and a display driving circuit.

In an embodiment of the present disclosure, leads of touch units in any two adjacent rows are led to the touch control circuit from different sides of the touch units, which improve the uniformity of leads.

In the related technology, leads between touch units and a touch control circuit are usually located on the same side of the touch units, which causes uneven distribution of the leads and adversely affects the uniformity of touch. In the embodiment of the present disclosure, leads of touch units in any two adjacent rows are led to the touch control circuit from different sides of the touch units, which improves the uniformity of leads, thereby improving the uniformity of touch.

The touch display panel according to an embodiment of the present disclosure includes the first touch electrode group as described above.

Specifically, the touch display panel according to an embodiment of the present disclosure further includes a second touch electrode group, and the second touch electrode group includes a plurality of second touch electrodes. The second touch electrodes are strip-shaped touch electrodes, and are disposed between two adjacent rows of sub-pixel units.

In specific implementations, the second touch electrodes and the gate lines are insulated from each other, the second touch electrodes and the data lines are insulated from each other, and an orthographic projection of each of the second touch electrodes onto the display substrate is between orthographic projections of adjacent sub-pixel units onto the display substrate. The second touch electrodes are led out through corresponding second leads. In a case that the touch display panel according to an embodiment of the present disclosure is a self-capacitive touch display panel, the second touch electrodes are grounded.

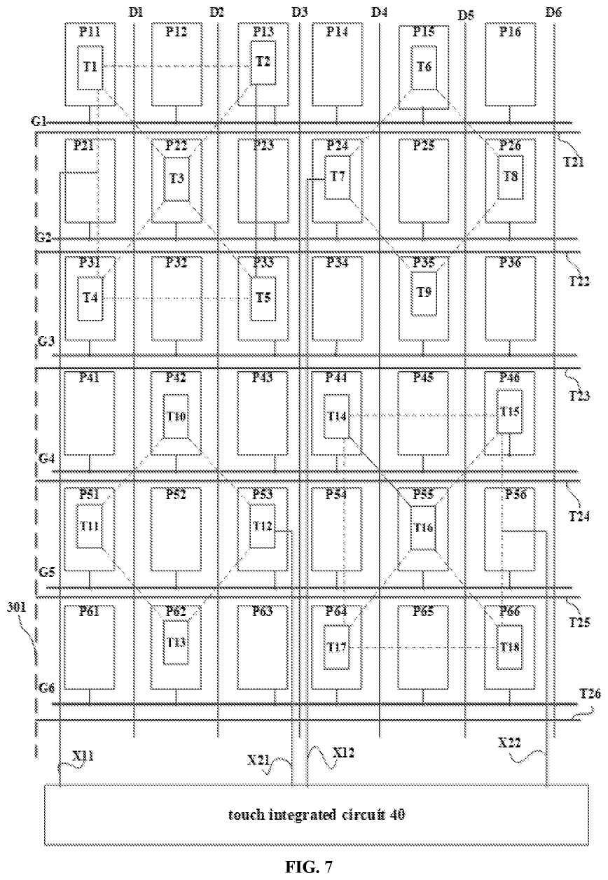

As shown in FIG. 7, based on the embodiments of the touch electrode group shown in FIG. 6, the touch display panel according to embodiments of the present disclosure further includes a second touch electrode group.

The second touch electrode group includes six second touch electrodes: a first row of second touch electrode T21, a second row of second touch electrode T22, a third row of second touch electrode T23, a fourth row of second touch electrode T24, a fifth row of second touch electrode T25, and a sixth row of second touch electrode T26.

Second touch electrodes T21, T22, T23, T24, T25 and T26 are arranged laterally, that is, T21, T22, T23, T24, T25 and T26 may be arranged parallel to gate lines. T21 is located between the first row of sub-pixel units and the second row of sub-pixel units, T22 is located between the second row of sub-pixel units and the third row of sub-pixel units, T23 is located between the third row of sub-pixel units and the fourth row of sub-pixel units, T24 is located between the fourth row of sub-pixel units and the fifth row of sub-pixel units, T25 is located between the fifth row of sub-pixel units and the sixth row of sub-pixel units, and T26 is disposed below the sixth row of sub-pixel units.

Second touch electrodes T21, T22, T23, T24, T25 and T26 may be led out through a second lead 301.

In an embodiment of the present disclosure, the second touch electrode may be a touch scan electrode, but is not limited thereto.

A touch display device is further provided according to embodiments of the present disclosure, which may be any product or component having a display function, such as a mobile phone, a tablet computer, a television, a display, a notebook computer, a digital photo frame, a navigator, and the like.

The above embodiments are optional implementations of the present disclosure. It should be noted that numerous improvements and retouches can be made by those of ordinary skill in the art without departing from principles described in the present disclosure, and these improvements and retouches shall also be regarded as the protection scope of the present disclosure.

What is claimed is:

1. A touch display panel, comprising:
a display substrate;
a plurality of sub-pixel units arranged in an array on the display substrate; and
a first touch electrode group comprising a plurality of touch units arranged in an array on the display substrate,
wherein at least one of the plurality of touch units comprises a plurality of touch electrode blocks that is electrically connected, each of the plurality of touch electrode blocks is disposed corresponding to one sub-pixel unit, and an orthographic projection of each touch electrode block onto the display substrate is within an orthographic projection of the corresponding sub-pixel unit onto the display substrate,
wherein a positional relation between two adjacent touch electrode blocks comprises at least one of:
two adjacent touch electrode blocks being located in a same row, and two sub-pixel units corresponding to the two adjacent touch electrode blocks in the same row being spaced apart by x sub-pixel units, x being a positive integer; or
two adjacent touch electrode blocks being located in a same column, and two sub-pixel units corresponding to the two adjacent touch electrode blocks in the same column being spaced apart by x sub-pixel units.

2. The touch display panel according to claim 1, wherein x=1, two sub-pixel units corresponding to each two adjacent touch electrode blocks in a same row are spaced apart by one sub-pixel unit, and two sub-pixel units corresponding to each two adjacent touch electrode blocks in a same column are spaced apart by one sub-pixel unit.

3. The touch display panel according to claim 1, wherein the plurality of touch units comprises first touch units and second touch units, and the first touch units and the second touch units are arranged alternately in a row direction and in a column direction; and
an arrangement manner of touch electrode blocks comprised in each of the first touch units is different from an arrangement manner of touch electrode blocks comprised in each of the second touch units.

4. The touch display panel according to claim 3, wherein the number of touch electrode blocks comprised in each of the first touch units is different from the number of touch electrode blocks comprised in each of the second touch units.

5. The touch display panel according to claim 1, wherein a touch unit in an a-th row and a b-th column is electrically connected to a touch control circuit of the touch display panel through a lead in the a-th row and the b-th column, and a touch unit in an (a+1)-th row and the b-th column is electrically connected to the touch control circuit through a lead in the (a+1)-th row and the b-th column, a and b being positive integers, and wherein the lead in the a-th row and b-th column is located on a left side of the touch unit in the a-th row and b-th column, and the lead in the (a+1)-th row and the b-th column is located on a right side of the touch unit in the (a+1)-th row and the b-th column; or
the lead in the a-th row and the b-th column is located on a right side of the touch unit in the a-th row and the b-th column, and the lead in the (a+1)-th row and the b-th column is located on a left side of the touch unit in the (a+1)-th row and the b-th column.

6. The touch display panel according to claim 3, wherein each of the first touch units comprises five touch electrode blocks, four touch electrode blocks of the five touch electrode blocks are located in two rows, a square is formed by connected lines between any adjacent touch electrode blocks of the four touch electrode blocks, and the remaining touch electrode of the five touch electrode blocks is located at a center of the square.

7. The touch display panel according to claim 6, wherein each of the second touch units comprises four touch electrode blocks, the four touch electrode blocks of the second touch unit are located in three rows, and a square is formed by connected lines between any adjacent touch electrode blocks of the four touch electrode blocks of the second touch unit.

8. The touch display panel according to claim 3, wherein each of the first touch units comprises five touch electrode blocks;
the touch display panel comprises a sub-pixel unit in an m-th row and an n-th column, a sub-pixel unit in the m-th row and an (n+1)-th column, a sub-pixel unit in the m-th row and an (n+2)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in an (m+2)-th row and the n-th column, a sub-pixel unit in the (m+2)-th row and the (n+1)-th column, and a sub-pixel unit in the (m+2)-th row and the (n+2)-th column, m and n being positive integers;
an orthographic projection of a first touch electrode block in the first touch unit onto the display substrate is within an orthographic projection of the sub-pixel unit in the m-th row and the n-th column onto the display substrate;
an orthographic projection of a second touch electrode block in the first touch unit onto the display substrate is within an orthographic projection of the sub-pixel unit in the m-th row and the (n+2)-th column onto the display substrate;
an orthographic projection of a third touch electrode block in the first touch unit onto the display substrate is within an orthographic projection of the sub-pixel unit in the (m+1)-th row and the (n+1)-th column onto the display substrate;
an orthographic projection of a fourth touch electrode block in the first touch unit onto the display substrate is within an orthographic projection of the sub-pixel unit in the (m+2)-th row and the n-th column onto the display substrate; and
an orthographic projection of a fifth touch electrode block in the first touch unit onto the display substrate is within an orthographic projection of the sub-pixel unit in the (m+2)-th row and the (n+2)-th column onto the display substrate.

9. The touch display panel according to claim 3, wherein each of the second touch units comprises four touch electrode blocks;
the touch display panel comprises a sub-pixel unit in an m-th row and an n-th column, a sub-pixel unit in the m-th row and an (n+1)-th column, a sub-pixel unit in the m-th row and an (n+2)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in an (m+2)-th row and the n-th column, a sub-pixel unit in the (m+2)-th row and the (n+1)-th column and a sub-pixel unit in the (m+2)-th row and the (n+2)-th column, m and n being positive integers;
an orthographic projection of a first touch electrode block in the second touch unit onto the display substrate is within an orthographic projection of the sub-pixel unit in the m-th row and the (n+1)-th column onto the display substrate;
an orthographic projection of a second touch electrode block in the second touch unit onto the display substrate is within an orthographic projection of the sub-pixel unit in the (m+1)-th row and the n-th column onto the display substrate;
an orthographic projection of a third touch electrode block in the second touch unit onto the display substrate is within an orthographic projection of the sub-pixel unit in the (m+1)-th row and the (n+2)-th column onto the display substrate; and
an orthographic projection of a fourth touch electrode block in the second touch unit onto the display substrate is within an orthographic projection of the sub-pixel unit in the (m+2)-th row and the (n+1)-th column onto the display substrate.

10. The touch display panel according to claim 3, wherein each of the first touch units comprises two touch electrode blocks;
the touch display panel comprises a sub-pixel unit in an m-th row and an n-th column, a sub-pixel unit in the m-th row and an (n+1)-th column, a sub-pixel unit in an (m+1)-th row and the n-th column and a sub-pixel unit in the (m+1)-th row and the (n+1)-th column, m and n being positive integers;
an orthographic projection of a first touch electrode block in the first touch unit onto the display substrate is within an orthographic projection of the sub-pixel unit in the m-th row and the n-th column onto the display substrate; and
an orthographic projection of a second touch electrode block in the first touch unit onto the display substrate is within an orthographic projection of the sub-pixel unit in the (m+1)-th row and the (n+1)-th column onto the display substrate.

11. The touch display panel according to claim 3, wherein each of the second touch units comprises two touch electrode blocks;
the touch display panel comprises a sub-pixel unit in an m-th row and an n-th column, a sub-pixel unit in the m-th row and an (n+1)-th column, a sub-pixel unit in an (m+1)-th row and the n-th column and a sub-pixel unit in the (m+1)-th row and the (n+1)-th column, m and n being positive integers;
an orthographic projection of a first touch electrode block in the second touch unit onto the display substrate is within an orthographic projection of the sub-pixel unit in the m-th row and the (n+1)-th column onto the display substrate; and
an orthographic projection of a second touch electrode block in the second touch unit onto the display substrate is within an orthographic projection of the sub-pixel unit in the (m+1)-th row and the n-th column onto the display substrate.

12. The touch display panel according to claim 3, wherein each of the first touch units comprises five touch electrode blocks, and each of the second touch units comprises four touch electrode blocks;
the touch display panel comprises a sub-pixel unit in an m-th row and an n-th column, a sub-pixel unit in the m-th row and an (n+1)-th column, a sub-pixel unit in the m-th row and an (n+2)-th column, a sub-pixel unit in the m-th row and an (n+3)-th column, a sub-pixel unit in the m-th row and an (n+4)-th column, a sub-pixel unit in the m-th row and an (n+5)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, a sub-pixel unit in the (m+1)-th row and the (n+3)-th column, a sub-pixel unit in the (m+1)-th row and the (n+4)-th column, a sub-pixel unit in the (m+1)-th row and the (n+5)-th column, a sub-pixel unit in an (m+2)-th row and the n-th column, a sub-pixel unit in the (m+2)-th row and the (n+1)-th column, a sub-pixel unit in the (m+2)-th row and the (n+2)-th column, a sub-pixel unit in the (m+2)-th row and the (n+3)-th column, a sub-pixel unit in the (m+2)-th row and the (n+4)-th column, and a sub-pixel unit in the (m+2)-th row and the (n+5)-th column, m and n being positive integers;
an orthographic projection of a first touch electrode block in the first touch unit onto the display substrate is within an orthographic projection of the sub-pixel unit in the m-th row and the n-th column onto the display substrate;
an orthographic projection of a second touch electrode block in the first touch unit onto the display substrate is within an orthographic projection of the sub-pixel unit in the m-th row and the (n+2)-th column onto the display substrate;
an orthographic projection of a third touch electrode block in the first touch unit onto the display substrate is within an orthographic projection of the sub-pixel unit in the (m+1)-th row and the (n+1)-th column onto the display substrate;
an orthographic projection of a fourth touch electrode block in the first touch unit onto the display substrate is within an orthographic projection of the sub-pixel unit in the (m+2)-th row and the n-th column onto the display substrate;
an orthographic projection of a fifth touch electrode block in the first touch unit onto the display substrate is within an orthographic projection of the sub-pixel unit in the (m+2)-th row and the (n+2)-th column onto the display substrate;
an orthographic projection of a first touch electrode block in the second touch unit onto the display substrate is within an orthographic projection of the sub-pixel unit in the m-th row and the (n+4)-th column onto the display substrate;
an orthographic projection of a second touch electrode block in the second touch unit onto the display substrate is within an orthographic projection of the sub-pixel unit in the (m+1)-th row and the (n+3)-th column onto the display substrate;
an orthographic projection of a third touch electrode block in the second touch unit onto the display substrate is within an orthographic projection of the sub-pixel unit in the (m+1)-th row and the (n+5)-th column onto the display substrate; and
an orthographic projection of a fourth touch electrode block in the second touch unit onto the display substrate is within an orthographic projection of the sub-pixel unit in the (m+2)-th row and the (n+4)-th column onto the display substrate.

13. The touch display panel according to claim 3, wherein each of the first touch units comprises two touch electrode blocks, and each of the second touch units comprises two touch electrode blocks,
the touch display panel comprises a sub-pixel unit in an m-th row and an n-th column, a sub-pixel unit in the m-th row and an (n+1)-th column, a sub-pixel unit in the m-th row and an (n+2)-th column, a sub-pixel unit in the m-th row and an (n+3)-th column, a sub-pixel unit in an (m+1)-th row and the n-th column, a sub-pixel unit in the (m+1)-th row and the (n+1)-th column, a sub-pixel unit in the (m+1)-th row and the (n+2)-th column, and a sub-pixel unit in the (m+1)-th row and the (n+3)-th column, m and n being positive integers;
an orthographic projection of a first touch electrode block in the first touch unit onto the display substrate is within an orthographic projection of the sub-pixel unit in the m-th row and the n-th column onto the display substrate; and
an orthographic projection of a second touch electrode block in the first touch unit onto the display substrate is within an orthographic projection of the sub-pixel unit in the (m+1)-th row and the (n+1)-th column onto the display substrate;
an orthographic projection of a first touch electrode block in the second touch unit onto the display substrate is within an orthographic projection of the sub-pixel unit in the m-th row and the (n+3)-th column onto the display substrate; and
an orthographic projection of a second touch electrode block in the second touch unit onto the display substrate is within an orthographic projection of the sub-pixel unit in the (m+1)-th row and the (n+2)-th column onto the display substrate.

14. The touch display panel according to claim 1, wherein shapes of the plurality of touch electrode blocks are the same, and the sizes of the plurality of touch electrode blocks are the same.

15. The touch display panel according to claim 1, further comprising a second touch electrode group, wherein the second touch electrode group comprises a plurality of second touch electrodes, and each of the plurality of the second touch electrodes is a strip-shaped touch electrode, and is disposed between adjacent rows of sub-pixel units.

16. A touch display device, comprising the touch display panel according to claim 1.
